(19) United States
(12) Patent Application Publication
(10) Pub. No.: US 2023/0267367 A1
(43) Pub. Date: Aug. 24, 2023

(54) DISTANCE-BASED PAIR LOSS FOR COLLABORATIVE FILTERING

(71) Applicant: THE TORONTO-DOMINION BANK, Toronto (CA)

(72) Inventors: Maksims Volkovs, Toronto (CA); Zhaoyue Cheng, TORONTO (CA); Juan Felipe Perez Vallejo, TORONTO (CA); Jianing Sun, TORONTO (CA); Zhaolin Gao, TORONTO (CA)

(21) Appl. No.: 17/969,238

(22) Filed: Oct. 19, 2022

Related U.S. Application Data
(60) Provisional application No. 63/270,407, filed on Oct. 21, 2021.

(51) Int. Cl. G06N 20/00

(52) U.S. Cl. CPC G06N 20/00

(57) ABSTRACT

A recommendation system generates item recommendations for a user based on a distance between a user embedding and item embeddings. To train the item and user embeddings, the recommendation system user-item pairs as training data to focus on difficult items based on the positive and negative items with respect to individual users in the training set. In training, the weight of individual user-item pairs in affecting the user and item embeddings may be determined based on the distance of the particular user-item pair between user embedding and item embedding, as well as the comparative distance for other items of the same type for that user and for the distance of user-item pairs for other users, which may regulate the distances across types and across the training batch.

### CROSS-REFERENCE TO RELATED APPLICATION

This application claims the benefit of U.S. provisional application no. 63/270,407, filed Oct. 21, 2021, the contents of which is incorporated herein by reference in their entirety.

### BACKGROUND

This disclosure relates generally to recommendation systems, and particularly to recommendation systems using embeddings to generate recommendation scores.

Online systems manage and provide various items to users of the online systems for users to interact with. As users interact with the content items, users may express or reveal preferences for some items over others. The items may be entertainment content items, such as videos, music, or books, or other types of content, such as academic papers or products for purchase. It is advantageous for many online systems to include recommendation systems that suggest relevant items to users for consideration. Recommendation systems can increase frequency and quality of user interaction with online systems by suggesting content that a user is likely to be interested in or will interact with. For example, a recommendation system included in a video streaming server may identify and suggest videos that a user may like based on videos that the user has previously viewed.

In general, models for recommendation systems use preference information between users and items of an online system to predict whether a particular user will like an item. Items that are predicted to be of interest for the user may then be suggested to the user for consideration. Recommendation systems may have millions of users and millions of items in the online system, meaning that individual users’ interactions may be sparse because of the very large number of content items. For example, music and book recommendation systems may have hundreds of thousands or millions of individual items that could be recommended (e.g., an individual book or an individual song), while an individual user typically interacts with a very small fraction of the total items (e.g., tens or hundreds of books from among a million books in a repository).

In some recommendation systems, users and/or items may be represented as an embedding (e.g., a multi-dimensional vector). As recommendation systems are often used with online systems having very large numbers of users and items, even seemingly small improvements in effective prediction can have significant impact when applied across thousands or millions of users. The distance between a user and an item in the embedding space may be used to indicate the items likely to be preferred by a user, such that positive items (e.g., that the user has interacted with or shown a preference for) may be “closer” to the user in the embedding space than negative items (e.g., that the user has not interacted with or shown a preference for). In training, positive and negative items may be pushed “closer” or “farther” to one another in the embedding space. Typically, training of the user and item embeddings may use a pairwise loss, such as Bayesian Personalized Ranking (BPR), Triplet, etc., in which positive and negative training pairs may be compared and are equally weighted in affecting the strength of the “push” in training. In addition, when selecting and applying user-item pairs for training, often all positive user-item pairs in a batch may be used along with a set of (all) randomly-sampled negative user-item pairs. In addition, as noted above, the user-item pairs may each provide a similar weight to the loss function in modifying the embeddings. These approaches may neither focus training on difficult pairs nor enable the training to account for information from more global information in the training set available from other user-item pairs.

### SUMMARY

A recommendation system may learn the item and user embeddings by improving selection of user-item pairs for training and by modifying the weight of a user-item pair on training based on the distance (i.e., a proximity measure) between the respective user embedding and respective item embedding for the associated user and item of the user-item pair. In training, the recommendation system may modify the user and item embeddings such that positive interactions are “pulled” towards the user in an embedding space, while negative interactions are “pushed” away from the user. The distance between a user and an item may be used to evaluate the likelihood that a user will interact with an item, such that closer items may be considered positive and farther items are considered negative.

In some embodiments, the training set of user-item pairs is selected actively by identifying “hard” items for a particular user, such as positive items within a threshold distance of the closest negative item, or the negative items within a threshold distance of the farthest positive item. That is, for a given user, one positive item may have the maximum distance from the user, and negative items that are within that maximum distance plus a margin may be considered the “hard” negative items, while negative items that are farther away may be omitted from the training set, as they are far enough away from any positive items (to the user) that they may be unlikely to contribute to erroneous recommendations. Similarly, difficult positive items for a particular user (i.e., user-item pairs) may be selected that are within a threshold of the closest negative item. This may focus the selection of relevant item-user pairs on individual users and on the items that, with respect to that user, may be difficult to predict. This is also an adaptive approach, enabling the identification of difficult user-item pairs flexibly without requiring a defined margin distance with respect to the user, instead enabling the “hard” examples to be determined with respect to the positive and negative items for that particular user.

The user and item embeddings for a plurality of users and items may then be trained based on an error that accounts for the respective error of the different user-item pairs in the training set. The error may account for the accumulated error of the positive and negative examples to each user across the training set. With respect to individual user-item pairs, the contribution of the user-item pairs to the training may be affected by a weight determined based on the distance of the user-item pair (i.e., the distance between the user and item embedding). Rather than equally weighting each user-item pair in determining the “push” or “pull” of the user-item pair in adjusting the embeddings, each user-item pair receives a weight based on the distance of the user-item pair, which may include several different components, such as components based on the distance of the user-item pair (“user-item weight component”), the distance relative to other user-item pairs of the same type for the user (“same-type weight component” -- e.g., whether a positive user-item pair for a particular user is relatively closer or farther than other items), and whether the user-item pair is closer or farther relative to other user-item pairs of the same type for other users (“batch-type weight component” -- e.g., whether other positive user-item pairs in the batch are closer or farther from the respective other users). The respective effect of each user-item pair in a training iteration may then “push” negative user-item pairs and “pull” positive user-item pairs in proportion to the weight (e.g., as a combination of the weight components). Together, the user-item pair selection process may account for user-item pairs having a different type (e.g., selecting positive pairs for a user based on the closest negative pair), the distance of the pair itself, other pairs of that type for the same user, and other pairs of that type for other users (e.g., within the training batch). This approach may thus improve the amount of information learned from each user-item pair and enable the effect of each pair on modifying the embeddings to account for more global context of other user-item pairs.

This weighting process, which may thus account for four different components and incorporates distance information from other users, enables the model to better position the learned representations. Experiments on various recommendation model types and architectures demonstrate that this loss can be applied to different types of recommendation models (which may also be termed collaborative filtering (“CF”) models) and lead to significant gains with each model type. In particular, embodiments using this loss applied to a graph convolutional architecture yields new state-of-the-art results on four different datasets and improves on prior loss/weighing approaches.

### BRIEF DESCRIPTION OF THE DRAWINGS

FIG. 1 is a high-level block diagram of a system environment for a recommendation system, according to one embodiment.

FIG. 2 is an example block diagram of an architecture of the recommendation system, according to one embodiment.

FIG. 3 illustrates an example of user embeddings and item embeddings in a latent space, according to an embodiment.

FIGS. 4A-4B show an example for selecting user-item pairs for training the recommendation model, according to one embodiment.

FIGS. 5A-5C show example weight components for training user and item embeddings, according to one embodiment.

FIG. 6 shows an example distribution of user and item embeddings with different loss functions, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

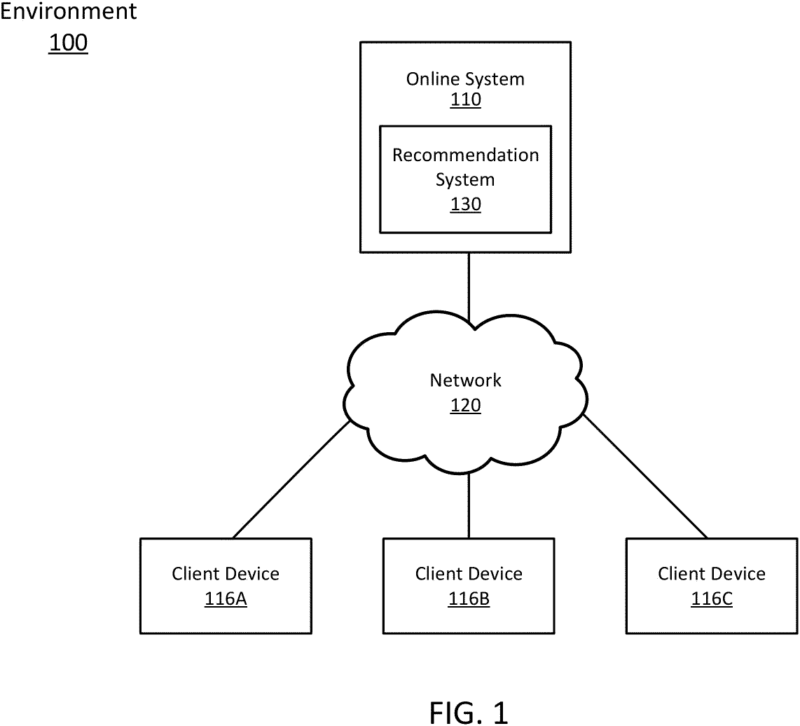

FIG. 1 is a high-level block diagram of a system environment for a recommendation system 130, in accordance with an embodiment. The system environment 100 shown by FIG. 1 includes one or more client devices 116, a network 120, and an online system 110 that includes a recommendation system 130. In alternative configurations, different and/or additional components may be included in the system environment 100. In this example, the recommendation system 130 is included within an online system 110 that provides content to users operating client devices 116. Users may also interact with content via the client devices 116, which provide that information to the online system 110. In other embodiments, the recommendation system 130 may provide recommendations (e.g., recommendation scores) without being a part of the online system 110. I.e., the recommendation system 130 may provide recommendations based on user interactions with content as a separate system from an online system 110 that provides content (or content suggestions based on the recommendations) to client devices 116.

The online system 110 manages and provides various items to users of the online systems for users to interact with. For example, the online system 110 may be a video streaming system, in which items are videos that users can upload, share, and stream from the online system 110. As another example, the online system 110 may be an e-commerce system, in which items are products for sale, and sellers and buyers can browse items and perform transactions to purchase products. As another example, the online system 110 may be article or content repositories, in which items are articles or content relating to different topics, and users can select and read articles that are of interest to them.

The recommendation system 130 identifies relevant items that users are likely to be interested in or will interact with and suggests the identified items to users of the online system 110. It is advantageous for many online systems 110 to suggest relevant items to users because this can lead to an increase in frequency and quality of interactions between users and the online system 110 and help users identify more relevant items. For example, a recommendation system 130 included in a video streaming server may identify and suggest movies that a user may like based on movies that the user has previously viewed. Specifically, the recommendation system 130 may identify such relevant items based on interaction information received from users as they interact with the online system 110. The interaction information contains preferences for some items by a user relative to other items. The interaction information may be explicitly given by users, for example, through a rating survey that the recommendation system 130 provides to users, and/or may be deduced or inferred by the recommendation system 130 from actions of the user. Depending on the implementation, inferred preferences may be derived from many types of actions, such as those representing a user’s partial or full interaction with a content item (e.g., consuming the whole item or only a portion), or a user’s action taken with respect to the content item (e.g., sharing the item with another user). In some embodiments, the interaction information is a Boolean value (e.g., zero or one), for example, indicating that a user did or did not interact with the content item. In addition, non-Boolean interaction information may be converted to a Boolean value for use by the recommendation system. For example, a threshold may be applied to a dynamic value, such that values over the threshold constitute an interaction (and a value of 1), and values under the threshold constitute no interaction (and a value of 0).

The recommendation system 130 predicts whether a particular user will like an item (i.e., will interact with an item the user has not previously interacted with) based on the interaction information. In various embodiments, the recommendation system 130 evaluates the likelihood of a user liking the item based on embeddings in a latent space. The latent space is a multi-dimensional space in which users and items may be “positioned” with different values of the various dimensions in the latent space. The latent space may be a Euclidian space, hyperbolic space, or other positional representation for users and items. In general, the distance (i.e., a proximity measure) a between a user and an item in the latent space is used to determine the likelihood a user may be interested in the item, such that an item having a relatively smaller distance to the user in the latent space may be considered to be more likely of interest to the user than an item having a relatively larger distance. The distance may be measured in various ways, such as a Euclidian distance, as a dot product, or via another proximity measure.

The evaluation of a particular item for a particular user may be referred to as a recommendation score. After scoring content items, a number of highest-scoring content items may be selected and recommended to the user, either by suggesting the item or directly presenting the item to the user. The recommendation system 130 may have millions of users and items of the online system 110. Each user typically interacts with a very small percentage of the items, such as .1%, .01%, or .001% or less of the total items. Similarly, while items may vary in popularity, each individual item is typically interacted with by less than 1%, .1%, or .01% of all users. As such, the interaction data for the users and items is relatively sparse given the large number of users and items for which to successfully generate customized user-item recommendation scores. The user and item embeddings provide an effective way to represent users and items for such sparse data and may be trained as discussed further below to more effectively represent preference information by selecting “difficult” user-item pairs for training and accounting for the relative distance of a user-item pair in determining the relative weight of a particular user-item pair in training the embeddings.

The client devices 116 are computing devices that display information to users and communicates user actions to the online system 110. While three client devices 116A, 116B, 116C are illustrated in FIG. 1, in practice many client devices 116 may communicate with the online system 110 in the environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone, or another suitable device. A client device 116 is configured to communicate via the network 120, which may comprise any combination of local area and wide area networks, including wired or wireless connections.

In one embodiment, a client device 116 executes an application allowing a user of the client device 116 to interact with the online system 110. For example, a client device 116 executes a browser application to enable interaction between the client device 116 and the online system 110 via the network 120. In another embodiment, the client device 116 interacts with the online system 110 through an application programming interface (API) running on a native operating system of the client device 116, such as IOS® or ANDROID™.

The client device 116 allows users to perform various actions on the online system 110 and provides interaction information to the recommendation system 130 about content items. For example, user interactions with items presented, selected, or interacted with by the user may be sent to the online system 110.

In one embodiment, the client devices 116 also allow users to rate items and provide preference information on which items the users prefer over the other. For example, a user of a movie streaming system may complete a rating survey provided by the recommendation system 130 to indicate how much the user liked a movie after viewing the movie. For example, the survey may request the user of the client device 116B to indicate the preference using a binary scale of “dislike” and “like,” or a numerical scale of 1 to 5 stars, in which a value of 1 star indicates the user strongly disliked the movie, and a value of 5 stars indicates the user strongly liked the movie. However, many users may rate only a small proportion of items in the online system 110 because, for example, there are many items that the user has not interacted with, or because the user chose not to rate items.

Interaction information is not limited to explicit user ratings and may also be included in other types of information, such as action information, provided to the recommendation system 130. For example, a user of a video streaming system who stops viewing a video after a short amount of time may be considered a negative interaction with the video, even though the user may not have explicitly provided a rating for the video. Similarly, a user watching a video to completion may be considered a positive interaction with the video without an explicit rating provided by the user.

The client devices 116 also receive item recommendations for users that contain items of the online system 110 that users may like or be interested in. The client devices 116 may present recommendations to the user when the user is interacting with the online system 110, as notifications, and the like. For example, video recommendations for a user may be displayed on portions of a website of the online system 110 when the user is interacting with the website via the client device 116. As another example, client devices 116 may notify the user through communication means such as application notifications and text messages as recommendations are received from the recommendation system 130.

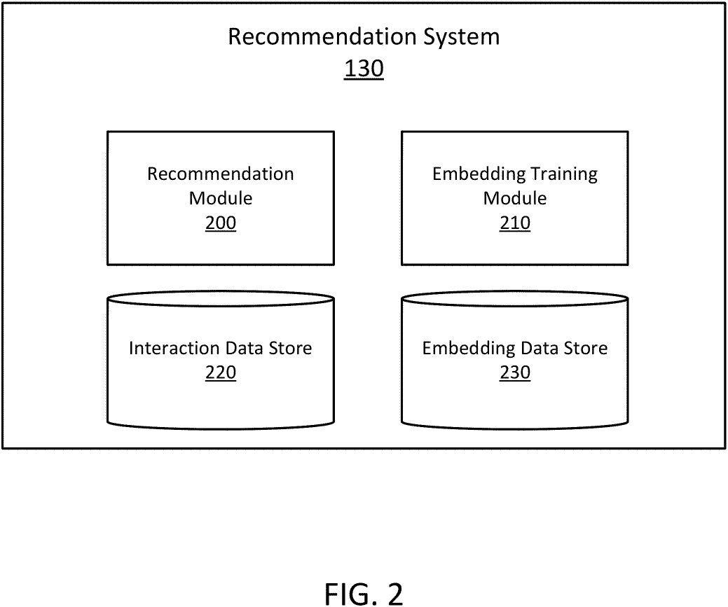

FIG. 2 is an example block diagram of an architecture of the recommendation system 130, according to one embodiment. The recommendation system 130 shown by FIG. 2 includes a recommendation module 200, an embedding training module 210, an interaction data store 220, and an embedding data store 230. In alternative configurations, different and/or additional components may be included in the system environment 100 and/or recommendation system 130. As such, while the present discussion emphasizes aspects of the recommendation system 130, in practice such systems (along with online system 110) may include additional modules, databases, and features. In addition, while the recommendation score discussed below generally discusses using embeddings in a latent space learned from interaction data, the embeddings may further be trained with additional features, and similarly, additional features may also be incorporated into the determination of a recommendation score for predicting a user’s likely interaction with a content item. In addition, the training discussed below (e.g., as performed by the embedding training module 210) generally focuses on training the user and item embeddings; in some embodiments a recommendation model may be trained with the embeddings that includes additional parameters for either determining the embeddings for a user and item (e.g., based on features associated with the user or item) or parameters for incorporating additional relational information, such as neighbor-based convolution or aggregation of user and item embeddings. Likewise, in application, the recommendation module 200 may apply such a recommendation model with the embeddings to determine recommendation scores for a particular user.

The interaction data store 220 manages interaction information for users of the online system 110. In other examples, the interaction information may not be managed by the recommendation system 130 and may be provided to the recommendation system 130 as a data set from an external source. In one embodiment, the interaction information may be represented (or transformed to represent) a sparse graph of nodes, each representing a user or an item. The interaction information between users and nodes may be represented as connections between the nodes. When there is a positive interaction between a user and an item (e.g., a user interacted with an item), a connection is created in the graph between the node associated with that user and the node associated with that item. In some embodiments, the connection between users and items is Boolean, such that a connection is created when there is an interaction, and no connection exists when there is no interaction. As discussed above, the percentage of items interacted with by each user, as well as the percentage of users interacting with each item is typically very low, yielding a sparse graph with few connections relative to the total number of users and items. As such, the interaction data store 220 includes data about a set of m users U = {u₁, ..., uₘ} and n items I = {i₁, ..., iₙ}. The interaction graph may also be represented as a sparse interaction matrix R, having dimensions m × n in which Rᵤᵢ has a value of 1 when there is an interaction and 0 otherwise. As such, each user-item pair may be considered an intersection of the interaction matrix, in which each user-item pair has an interaction type (i.e., a label) that may correspond to 1 for positive interactions and 0 for negative interactions. Each user u may thus be associated with a set of positive items associated with positive interactions (i.e., having the value 1 in the interaction matrix) and a set of negative items associated with negative interactions (i.e., having the value 0 in the interaction matrix). As discussed further with respect to training the embeddings, the training data (i.e., based on known positive/negative interactions) may include, for each user u, a set of positive items Pᵤ and negative items Nᵤ. Individual positive items Pᵤ for user u (i.e., a positive user-item pair) may be referenced with subscript ᵤⱼ, and individual negative items Nᵤ for user u (i.e., a negative user-item pair) may be referenced with subscript ᵤₖ. As items may be associated with positive interactions for some users and negative interactions from others, the same content item may appear in the positive item set for one user and the negative item set for another. As such, the user-item pair designation emphasizes the influence of the individual connections between individual users and individual items.

The embedding data store 230 maintains a set of embeddings in a latent space. Each embedding represents a location in the latent space for an item (an item embedding) or user (a user embedding). As such, each item may be associated with one of a plurality of item embeddings, and each user may be associated with one of a plurality of user embeddings.

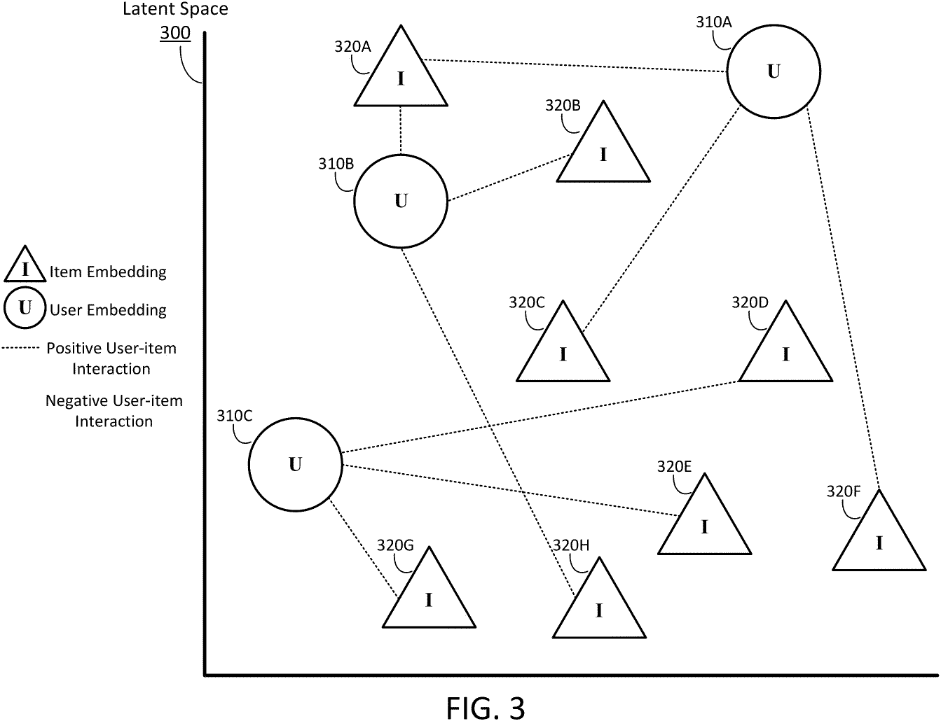

For a particular user u and item i, the position of the respective user embedding and item embedding may then be used in the determination of a recommendation score, e.g., based on the distance between the user embedding and item embedding. As shown and discussed below, these learned representations (i.e., the embeddings) in the latent space capture meaningful structure for the set of users and items latent in the interaction data and via the approaches discussed herein provide improved recommendation performance relative to prior recommendation systems. An example latent space is shown and discussed with respect to FIG. 3.

The recommendation module 200 may use the embeddings for users and items to generate recommendation scores and select one or more items to recommend (or automatically present) to a particular user. For a given user, the recommendation score may be evaluated for a set of items, which may include all possible items or a subset thereof. For each evaluated item, the recommendation score is generated for the user u and the item i. In one embodiment, the recommendation score is determined based on the distance in the latent space between the user embedding and the item embedding. The distance may be based on a Euclidian distance, dot product, or other distance measurement (e.g., depending on the type of latent space). In certain embodiments, a recommendation model may include additional parameters and additional features for determining a recommendation score in addition to the distance in the latent space. For example, the recommendation model may model the user and items as neighbors in a graph according to the positive interactions and perform graph convolutions on the user and item embeddings, or may account for additional factors or parameters in determining a final recommendation score based on the distance between user and item embeddings. Such additional factors may include additional characteristics or features of the user or item.

The embedding training module 210 trains the user embeddings and item embeddings for each item and user. To perform the training, embeddings may first be initialized (e.g., to random positions in the latent space), after which they may be trained based on the interaction data. The training may be performed iteratively based on batches of users and/or items to modify the position of the user and item embeddings. The respective contribution of the user-item pairs to the modification of the positions of the user and item embeddings may be affected by a weight that may account for one or more types of components as further discussed. In general, the embedding training module 210 may train the position of the embeddings to reduce an error with respect to the distance of items to users, such that a user’s user embedding is relatively closer (in the embeddings’ latent space) to item embeddings for items that the user has positively interacted with, and relatively farther away from item embeddings for items that the user has negatively interacted with. The embedding training module 210 modifies the embeddings to reduce the determined error and/or based on the weighing of the respective user-item pairs.

FIG. 3 illustrates an example of user embeddings and item embeddings in a latent space 300, according to an embodiment. The example of FIG. 3 shows the positions of user embeddings 310A-C and item embeddings 320A-H in the latent space 300. The latent space 300 is shown as a two-dimensional space; in practice, the latent space may include tens or hundreds or more of dimensions for representing the position of users and items. As such, the example of FIG. 3 may also be considered as a projection of the multi-dimensional space onto the two-dimensional space for illustration.

The example of FIG. 3 shows three user embeddings 310A-C and eight item embeddings 320A-H. The users may have positive or negative interactions with individual items, such that each user-item pair may be labeled positively or negatively as discussed above. User-item pairs labeled with a positive interaction are indicated FIG. 3 with dotted lines indicating a connection between the user-item pairs, such as the dotted line between user embedding 310A and item embedding 320A. In the example of FIG. 3, the user associated with user embedding 310A has a positive interaction with items associated with three item embeddings 320A, item embedding 320C and item embedding 320F.

The example of FIG. 3 may show the position of the respective embeddings before the training of the position of the embeddings has been completed. As discussed above, the distance between user and item embeddings may signal the likely interaction of users with items, such that, after training, the items that a user has interacted with generally should be trained towards a distance closer to the user than items that the user has not interacted with. In this example, user embedding 310A has a shorter distance to item embedding 320B and item embedding 320D than item embeddings 320A, 320C, and 320F associated with items for which the user has interacted. As such, during training of the embeddings, the user-item pairs for user embedding 310A and the item embeddings 320A, 320C, and 320F may be encouraged reduce the respective distances (e.g., by moving the respective user and item embeddings), while the user-item pairs for user embedding 310A and the item embeddings 320B and 320D may be encouraged to increase the respective distances. As illustrated in FIG. 3, each user may typically have interacted with a small number of items, such that the number of negative examples available for use in training may far outweigh the number of positive examples. In addition, even among the positive items, some positive items may have embeddings that are relatively close to the respective user, such as user embedding 310B and item embedding 320A in this example.

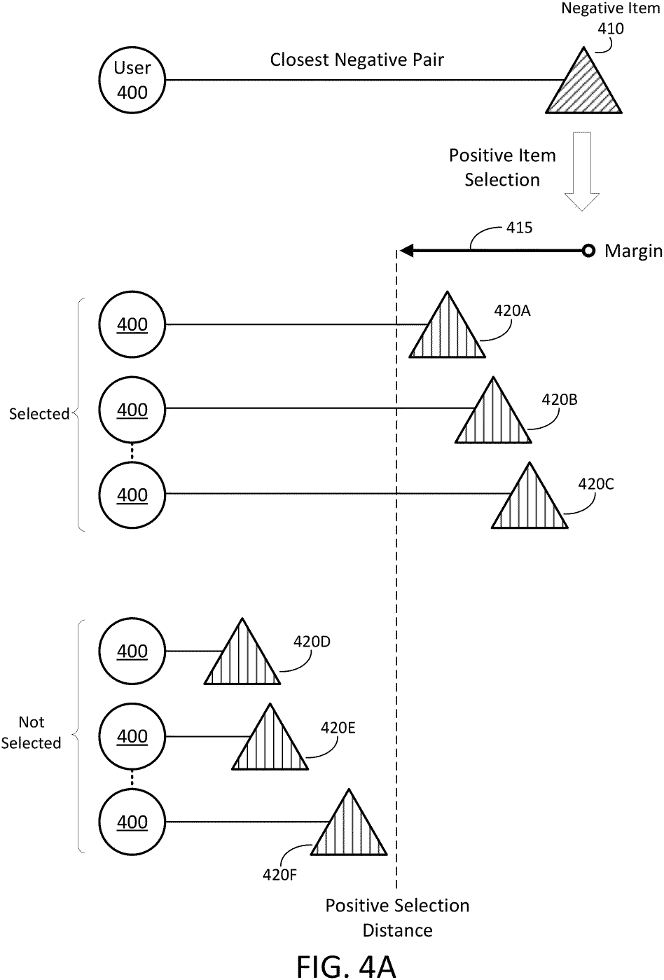

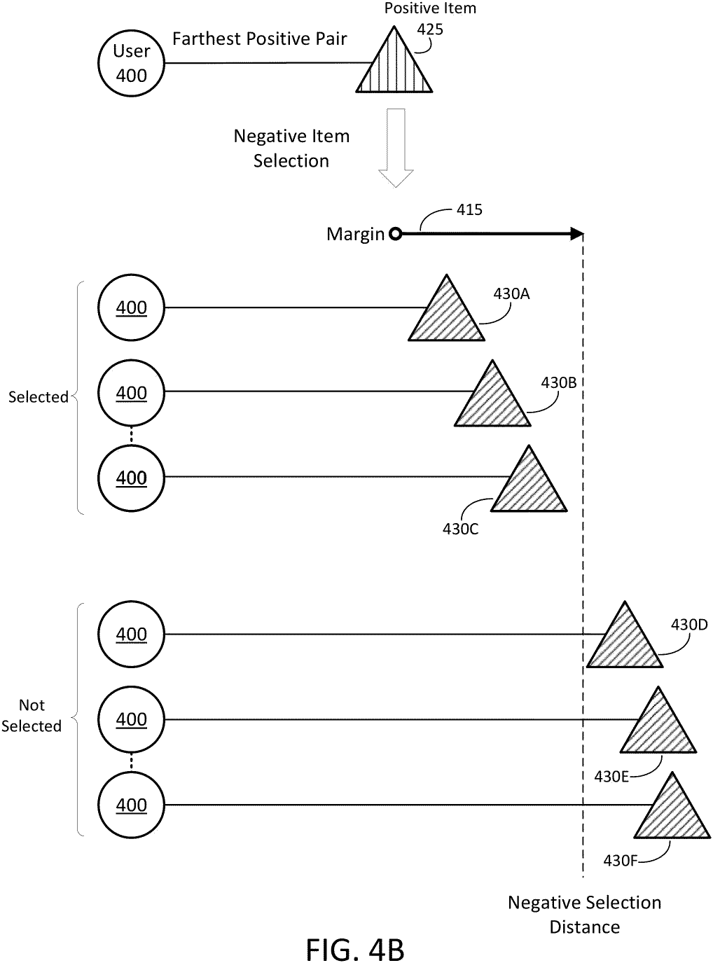

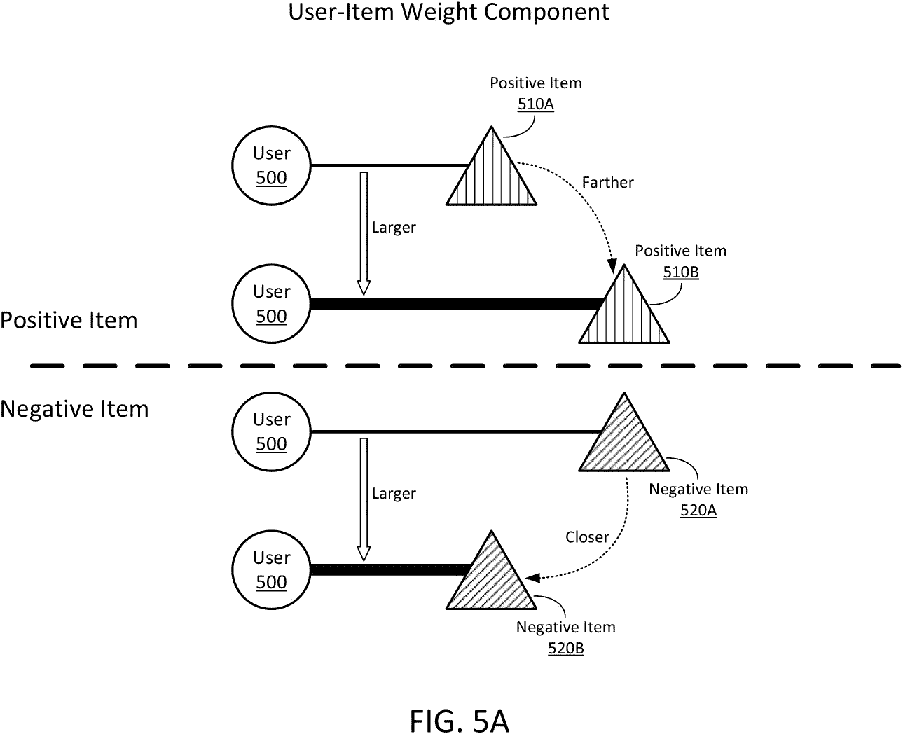

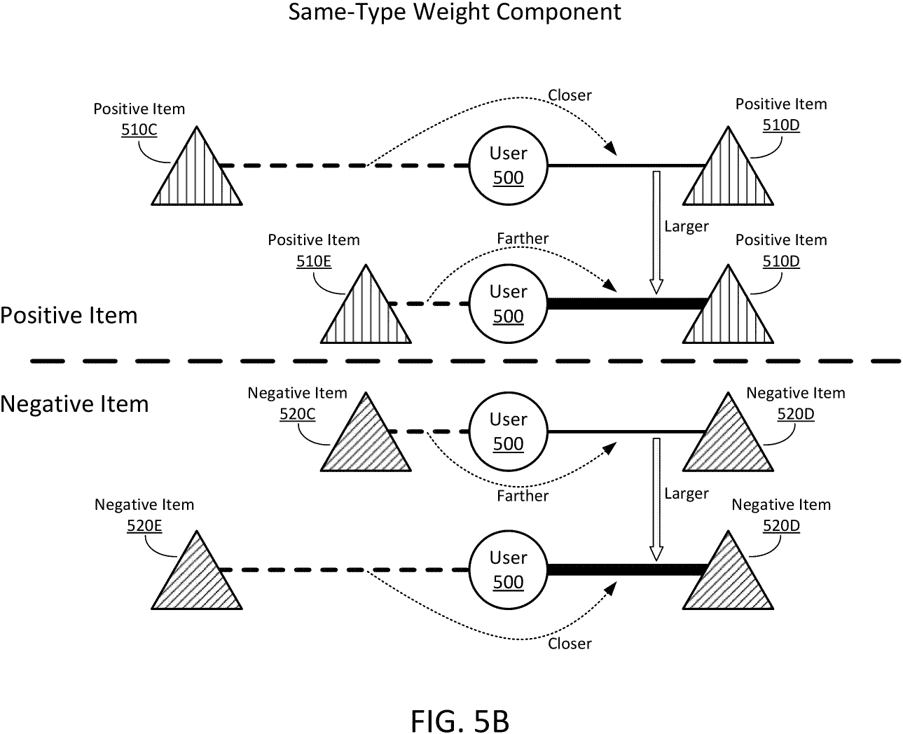

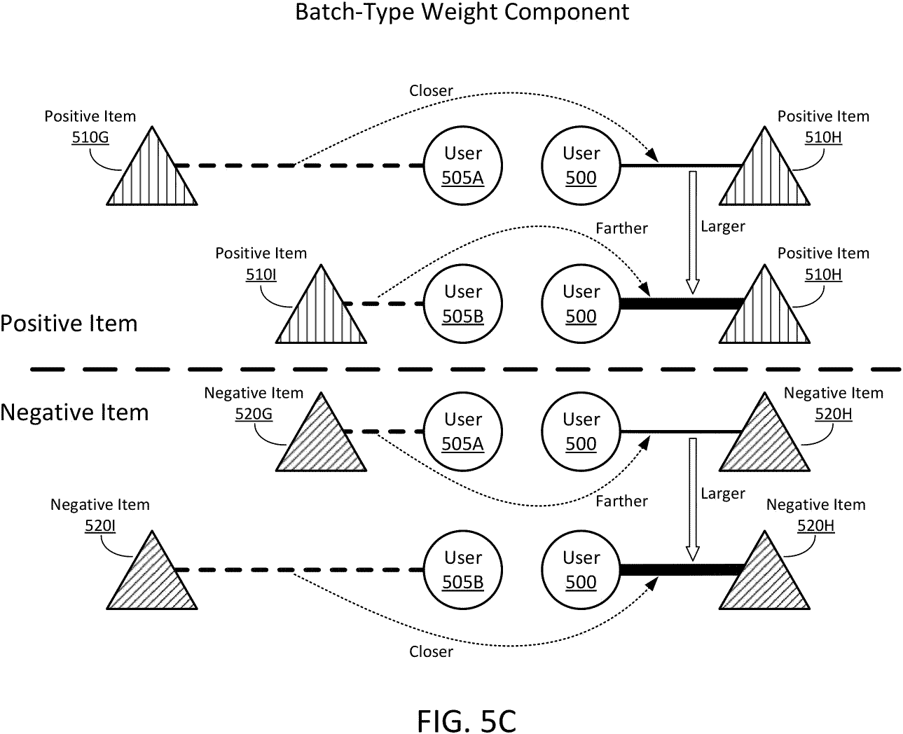

As such, in training the embeddings, e.g., as performed by the embedding training module 210, may use the distance between user-item pairs to select “difficult” user-item pairs for a particular training batch (e.g., for a training iteration) as discussed with respect to FIGS. 4A-4B, and may weigh the contribution of each of the selected user-item pairs for modifying the user and item embeddings with one or more weight components that may include the user-item distance (a “user-item weight component”), the distance of the user-item pair relative to other user-item pairs for the user having the same type (a “same-type weight component”), and the distance of the user-item pair relative to other user-item pairs for other users that have the same type (a “batch-type weight component”). The weights and weight components are further discussed with respect to FIGS. 5A-C.

### User-Item Pair Selection

FIGS. 4A-4B show an example for selecting user-item pairs for training the recommendation model, according to one embodiment. Training the embeddings, e.g., by the embedding training module 210, typically processes the complete training set of users and items in batches, particularly for applications in which the number of users and items may be in excess of hundreds of thousands, millions, tens of millions, or more. A group of user-item pairs may be selected for a training batch, the user and item embeddings modified based on the training batch, and another batch may be processed, such that the user and item embeddings are iteratively refined by the training as the additional batches are processed.

In some embodiments, a set of users may be selected for the training batch, and a set of user-item pairs for those users may be selected for training, such that the training set includes user-item pairs for each user that includes items with positive interactions and items with negative interactions. The selected users for a batch may be selected randomly, based on a partition of the user/item set, as the users with the most or fewest positive interactions, or on some other basis. The items with positive interactions may be referred to as positive items, and the items with negative interactions may be referred to as negative items.

For each user included in the training batch, initially, a group of positive and a group of negative items (i.e., different items that have a positive and negative interaction label with respect to a particular user) may be considered as candidates for selection in the training set. The positive items to be considered as candidates may include the complete set of positive items that the user has interacted with in one embodiment, and the negative items to be considered as candidates may include the complete set of negative items (selected based on the type of item or may be a randomly-selected subset of negative items). As discussed above, each user and item may be associated with a respective user embedding and item embedding, such that a distance can be determined or identified for each user-item pair based on the position of the respective user embedding of the user and the item embedding of the item. As shown in FIGS. 4A-4B, the distance of the items to the user in the latent space (e.g., the distance of the user-item pair based on the respective user and item embeddings) may be used select “hard” user-item pairs. The “hard” user-item pairs may reflect negative items that are relatively close to the user and positive items that are relatively far from the user.

FIG. 4A illustrates the selection of positive user-item pairs for the training set for a user 400. The candidate user-item pairs for a batch may include a number of positive items that are relatively close to the user 400, along with negative items that are relatively far from the user 400. The candidate user-item pairs may include “easy” predictions for the model, as the evaluation of the proximity of the user and item is unlikely to err in predicting the similarity score of a close positive item or the similarity score of a distant negative item. Rather, the selection of user-item pairs in one embodiment focuses on the selection of user-item pairs along a boundary that may separate positive and negative pairs from one another. While an explicit distance separating positive and negative items from a user may be a desired result of the training, in practice such a boundary may be difficult to explicitly learn. In addition, particularly in the early rounds of training, some negative items may be closer to the user 400 than some positive items, and vice versa. Similarly, the relevant distance may differ for different users and for different batches. As such, in one embodiment, the user-item pairs selected for the training set may be adaptively selected based on the distance of the other type of training item (e.g., positive items selected based on a closest negative item, and negative items selected based on a farthest positive item).

To do so, in one embodiment, the positive pairs may be selected based on the closest negative pair (e.g., in the set of candidate negative user-item pairs for the training batch). As such, the distances of the negative user-item pairs to a user may be evaluated to identify the negative item 410 having the minimum (e.g., smallest) distance to the user 400. The distance of the closest negative item 410 to the user 400 may then be used to set a positive selection distance for selecting positive items 420A-F. In some embodiments, the positive selection distance may be set based on the distance of the negative item 410 in combination with a margin 415 (which may also be termed a “threshold distance”). Stated another way, the selected positive user-item pairs are within the margin (threshold distance) of the minimum distance of the negative item 410, and other candidate positive user-item pairs are not included in the training set. The margin 415 may be a specified value that may be set based on the type of latent space or set empirically for a given latent space or model architecture. In further embodiments, the margin 415 may be a percentage or portion of the distance of the closest negative item embedding.

In the example of FIG. 4A, the distance from user embedding 400 (which may also be referred to as user 400) to item embeddings 420A, 420B, and 420C (which may also be referred to as items 420A-C) are within the margin of the distance of the negative item 410, and the corresponding user-item pairs may be selected for the training set. Similarly, the distance from user 400 to item embeddings 420D, 420E, and 420F are not selected for the training set as they are too close to the user embedding 400 relative to the distance (minus margin 415) of the negative item embedding 410. For convenience, reference to a “position” or “distance” between a user or item may refer to the respective item embedding and user embeddings, such that the user embedding 400 may be referred to as user 400, and the respective item embeddings 410 and 420A-F may be referred to as items 410 and 420A-F.

FIG. 4B shows a similar process for selecting negative user-item pairs. Where the positive items that were “farthest” and within the threshold distance of the distance associated with the closest negative item embedding, in embodiments the negative items may similarly be selected as those that are closest relative to the farthest positive item 425 to the user 400. As discussed above, the distances of the user-item pairs may be determined for the positive user-item pairs to determine the positive user-item pair with the highest distance (e.g., the farthest positive user-item pair). Similar to the positive user-item pair selection, the negative user-item pairs may be selected as those that are within a margin 415 of the distance of the farthest positive item 425, which may together be a negative selection distance, such that negative items closer than the negative selection distance may be selected for the training set. In the example of FIG. 4B, item embeddings 430A, 430B, and 430C have distances to the user 400 closer than the negative selection distance and are selected for the training set. Similarly, item embeddings 430D, 430E, and 430F have distances to the user 400 greater than the negative selection distance and thus are not selected for the training set.

This selection process for “hard” examples allows the effective selection distance to be adaptive based on the particular user 400 and the particular negative item 410 are selected for the training set. In addition, it may encourage the selection of user and item pairs that encourage at least the margin’s distance between the closest positive pair and the farthest negative pair. Further, it allows each type of interaction to affect the selection of user-item pairs of the other type, and may not require an error function in training (i.e., a training objective) that explicitly compares the distance of positive and negative items with respect to a user in determining the relative contribution of the items to the modified embeddings. For example, a traditional Triplet loss may evaluate the position of a user embedding, the position of a positive item embedding, and the position of a negative item embedding together for an error relating to the triplet of embeddings: Lₜᵣᵢₚₗₑₜ(u,j,k) = [Eᵤⱼ - Eᵤₖ + λ]. In which the loss for a user u, with respect to positive item j and negative item k is based on the distance Eᵤⱼ between user u and positive item j, the distance Eᵤₖ between user u and positive item k, and a margin λ. In this formulation, the selection of specific items for the loss may significantly affect the resulting adjustment of the user and item embeddings, and each user-item pair may affect the adjustment of the embeddings by similar amounts (e.g., have the same weight on the magnitude of the “push” or “pull” of embedding adjustments). As discussed in FIGS. 5A-5C, weighing the user-item pair with weight components based on the user-item pair distance and other items of the same type in the training set may significantly improve the training of embeddings and resulting recommendations based on the embeddings.

### User-Item Pair Weights

FIGS. 5A-5C show example weight components for training user and item embeddings, according to one embodiment. To train the user and item embeddings, an error may be used that accounts for the respective positions of the users with respect to individual positive and negative items by summing the error for positive items and error for negative items and encouraging user and item embeddings of positive user-item pairs closer and user and item embeddings of negative pairs farther way. Particularly, in one embodiment, a loss objective for training the embeddings is a “mixed centric loss” (MCL) that has a term for positive user-item pairs and a term for negative user-item pairs as shown in Equation 1 for a batch of users m:

$$\begin{matrix}{L}_{M C L} = \frac{1}{\text{α}} log \left[1 + \frac{1}{m} {\sum }_{u ∈ B} {\sum }_{j ∈ {P}_{u}^{s}} {e}^{\text{α} \left({E}_{u j} + {λ}_{p}\right)}\right] \\ + \frac{1}{β} log \left[1 + \frac{1}{m} {\sum }_{u ∈ B} {\sum }_{k ∈ {N}_{u}^{s}} {e}^{- β \left({E}_{u k} + {λ}_{n}\right)}\right]\end{matrix} \qquad \text{Equation 1}$$

Overall, the MCL loss sums, for each user u of a set of users B, a contribution from each positive user-item pair j across the set of that user’s positive items

$${P}_{u}^{s}$$

and similarly sums a contribution for each negative user-item pair k across the set of that user’s negative items

$${N}_{u}^{s} .$$

Additionally, in Equation 1, α and β are terms for controlling the loss contribution of the positive and negative pairs, λₚ and λₙ, are hyperparameters controlling the margin for positive and negative pairs, and Eᵤⱼ, Eᵤₖ are the distance for a positive user-item pair and a negative user-item pair, respectively.

Rather than considering the overall loss, the training loss may also be analyzed from the perspective of the effect for individual user-item pairs in which the magnitude of a “push” or “pull” from a given user-item pair is given by the difference in loss relative to the difference in changed distance:

$${w}_{u j}^{+} = \frac{\partial L}{\partial {E}_{u j}} , {w}_{u k}^{-} = - \frac{\partial L}{\partial {E}_{u k}} \qquad \text{Equation 2}$$

As such, with respect to an individual user-item pair, the contribution for a particular positive user-item pair may be given by:

$${w}_{u j}^{+} \begin{matrix}= \frac{1}{m} . \frac{{e}^{\text{α} {\text{Ε}}_{u j}}}{{e}^{- \text{α} {λ}_{p}} + \frac{1}{m} \sum {}_{{u}^{′} ∈ B} \sum {}_{i ∈ {P}_{{u}^{′}}^{s}} {e}^{\text{α} {\text{Ε}}_{{u}^{′} j}}} \\ = \frac{1}{m} . \frac{1}{{w}_{1}^{+} \left(u , j\right) + {w}_{2}^{+} \left(u , j\right) + {w}_{3}^{+} \left(u , j\right)}\end{matrix} \qquad \text{Equation 2}$$

In which the respective terms

$${w}_{1}^{+} , {w}_{2}^{+} , \text{and} {w}_{3}^{+}$$

may relate to terms affected by a user-item distance, a distance of other items for that user, and a distance for other users, as discussed further below.

The individual weight components may thus be given in one embodiment as:

$$\begin{matrix}{w}_{1}^{+} \left(u , j\right) = {e}^{- \text{α} \left({E}_{u j +} {λ}_{p}\right)} \\ {w}_{2}^{+} \left(u , j\right) = \frac{1}{m} {\sum }_{i ∈ {P}_{u}^{s}} {e}^{- \text{α} \left({E}_{u i} - {E}_{u j}\right)}\end{matrix}$$

$${w}_{3}^{+} \left(u , j\right) = \frac{1}{m} {\sum }_{{{u}^{′} ∈ B}_{{u}^{′} \neq u}} {\sum }_{i ∈ {P}_{{u}^{′}}^{s}} {e}^{\text{α} \left({E}_{{u}^{′} i} - {E}_{u j}\right)} \qquad \text{Equation 3}$$

Each of the weight components w₁, w₂, and w₃ may have corresponding values for negative user-item pairs, and the components are further discussed below. Briefly, w₁ accounts for the distance of the user-item pair, w₂ accounts for the distance of the user-item pair relative to the distance of other user-item pairs of the same type (e.g., the relative distance

$$\left({E}_{u i} - {E}_{u j} \text{for} i ∈ {P}_{u}^{s}\right)$$

and w₃ accounts for the distance of the user-item pair relative to the user-item pairs of the same type for other users (e.g., for different users u′ ≠ u, the relative distance of E_{u′i} - Eᵤⱼ of items in other users’ set of positive user-item pairs

$$\left(i ∈ {P}_{{u}^{′}}^{s}\right) .$$

Similarly, the components for a weight for a negative user-item pair may be given by similar terms:

$${w}_{u k}^{-} = \frac{1}{m} . \frac{1}{{w}_{1}^{-} \left(u , k\right) + {w}_{2}^{-} \left(u , k\right) + {w}_{3}^{-} \left(u , k\right)} \qquad \text{Equation 4}$$

With corresponding weight components for negative weights:

$$\begin{matrix}{w}_{1}^{-} \left(u , k\right) = {e}^{β \left({E}_{u k} + {λ}_{n}\right)} \\ {w}_{2}^{-} \left(u , k\right) = \frac{1}{m} {\sum }_{i ∈ {N}_{u}^{s}} {e}^{β \left({E}_{u k} - {E}_{u i}\right)} \\ {w}_{3}^{-} \left(u , k\right) = \frac{1}{m} {\sum }_{{{u}^{′} ∈ B}_{{u}^{′} \neq u}} {\sum }_{i ∈ {N}_{{u}^{′}}^{s}} {e}^{β \left({E}_{u k} - {E}_{{u}^{′} i}\right)}\end{matrix} \qquad \text{Equation 5}$$

The respective weight components w₁, w₂, and w₃ are discussed with respect to FIGS. 5A-5C and may respectively refer to a user-item weight component, same-type weight component, and a batch-type weight component. Although these components as discussed here as derived from the loss function of Equation 1, in various embodiments, different loss functions may be used, such that the weights applied to particular user-item pairs may differ from the particular equations shown above. Accordingly, various embodiments may thus include components for weighing the contribution of a particular user-item pair based on the principles as discussed below to account for the distance of a particular user-item pair as well as the context of other user-item pairs.

In addition, while generally discussed with respect to “positive” and “negative” items, in other embodiments, these principles may be applied to different types of interactions; for example, while “positive” and “negative” are binary interactions, such that positive item embeddings may be preferred to be closer and negative items farther from the user embeddings, other embodiments may use scaled preferences (e.g., a rating scale from 1-10) or another classification designating preference types (e.g., positive, neutral, negative). Thus, while discussed with respect to positive and negative examples, these principles may be applied for discriminating between different types for which the closeness of user and item embeddings in the latent space may indicate the likely membership of interaction types (e.g., where closer is better).

An example effect of a user-item weight component (e.g., w₁) is shown in FIG. 5A. This weight component may directly relate to the distance between a user and item embedding and may emphasize improving the discrimination value of the distance between item and user, such that positive items that are farther away receive higher weights, and negative items that are closer receive lower weights. That is, “farther” positive items may be mistaken for negative items, and “closer” negative items may be mistaken for positive items in evaluation. As such, the user-item weight component may relatively increase (or decrease) the weight for modifying embeddings related to user-item pairs based on the distance. With respect to the same user embedding 500, the user-item pair for a positive item 510A may thus have a lower user-item weight component compared to a positive item 510B that is farther away from the user embedding 500 (i.e., the user-item pair for positive item 510B may have a relatively higher weight). Similarly, for negative user-item pairs, the contribution of the user-item weight component for a positive item 510 may relatively decrease for negative user-item pairs that have a higher distance and relatively increase for negative user-item pairs that have a lower distance. As such, this weight component for a user-item pair of negative item 520A is relatively smaller compared to this weight component for the user-item pair of negative item 520B.

Where the user-item weight component may directly relate to the distance between a user embedding and item embeddings, the same-type weight component and batch-type weight component may influence the weight of a user-item pair based on other items of the same type. For example, the same-type weight component may influence the weight of a positive user-item pair based on other positive user-item pairs for the same user.

FIG. 5B shows this effect for a user-item pair of the user embedding 500 to positive item embedding 510D. In this example, the other positive user-item pairs 510C, 510E affect the weight of the user-item pair weight for user embedding 500 and positive item embedding 510D. In particular, for positive user-item pairs, other user-item pairs that have a higher distance may relatively reduce the weight of the user-item pair, while other user-item pairs may relatively increase the weight of the user-item pair. As such, the distance of positive item embedding 510C to user embedding 500 is higher than the distance of positive item embedding 510E, such that the same-type weight component may provide a relatively lower weight (and may even be a negative weight) based on positive item embedding 5 10C, and a relatively higher weight for positive item 510E. In some embodiments, the relative distance of the user-item pair relative to the other user-item pairs is used to determine the respective contribution of the other pairs (here, related to positive item embeddings 510C, 510E).

To determine the overall same-type weight component, the contributions for each other positive user-item pair may be combined (e.g., summed) and adjusted for the number of other user-item pairs (e.g., such that the total effect is averaged across the other user-item pairs). The effect of the same-type weight component is to regularize the distance for the user-item pairs having the same interaction type for the user, such that closer positive items, relative to other positive items for this user, are weighed less than farther positive items, relative to other positive items for this user, encouraging the highest distance positive user-item pairs, relative to a particular user, to have higher weights in moving towards the user.

Negative items may similarly be evaluated by the same-type weight component, except with corresponding adjustments to more-highly weigh relatively closer negative items and less-highly weigh relatively farther negative items. Thus, the weight for the user-item pair of user embedding 500 and negative item embedding 520D may be affected by negative items 520C and 520E. For the negative user-item pairs, the items closer to the user may decrease the same-type weight component, such that negative item embedding 520C, closer to the user, provides a lower same-type weight component for user-item pair of item embedding 520D compared to the relatively higher weight for item embedding 520E, which is farther from the user than the item embedding 520D. As such, the negative user-item pairs having a lower distance, relative to other negative user-item pairs for this user, may have a higher same-type weight component. As with the positive items, the effect of the same-type weight component may be to regularize the distance of negative items with respect to a user and increase the weight for the negative user-item pairs that, relative to other negative user-item pairs of that user, have a smaller distance to the user.

The batch-type weight component may perform a similar function as the same-type weight component, but may further regularize the user-item pair distances with respect to the training set of user-item pairs (e.g., for a particular training batch/iteration). That is, where the same-type weight component may provide a normalization with respect to the other user-item pairs in a given user’s set of positive user-item pairs, the batch-type weight component may normalize across the distances for the training set, encouraging the weight for adjusting item and user embeddings to adjust the distance between user and item embeddings to be similar for the same interaction type across different users and items.

As such, as shown in FIG. 5C, the distance for a user embedding 500 to a positive item embedding 510H may be compared to a distance between another user embedding 505A to other positive item 510G, and the distance of another different user embedding 505B to item embedding 510I. The batch-type weight component for the current positive user-item pair may thus be relatively smaller when the distance of the other positive user-item pair is larger. Thus, the batch-type weight component for user embedding 500 to positive item embedding 510H based on user embedding 505A to positive item 510G may be relatively smaller compared to the batch-type weight component for user 505B to positive item 510I, which has a smaller distance relative to user embedding 500 to positive item 510H. Though different user embeddings 505A, 505B and positive item embeddings 510G, 510I are shown in FIG. 5C, in some embodiments, the batch-type weight component may account for multiple (or all) positive user-item pairs for a particular user, and different users may have positive user-item pairs to the same item (which may have different distances). For example, user embedding 505A and user embedding 505B may have different distances to positive item embedding 510I, and both users may be associated with positive interactions to that item.

The batch-type weight component may operate similarly for the negative user-item pairs, except to increase with smaller relative distances (i.e., closer to the user) and decrease with higher relative distances (i.e., farther from the user). As such, the batch-type weight component for user embedding 500 to negative item embedding 520H may have a relatively small weight contribution attributable to a smaller distance of other user embedding 505A to negative item embedding 520G and a relatively larger weight contribution attributable to a larger distance of the other user embedding 505B to negative item embedding 520I. As with the same-type weight component, the relative contribution of the batch-type weight components from other user-item pairs on a given user-item pair may be summed, combined, or averaged to determine the total value for the batch-type weight component.

The weight components discussed here may also be beneficial in being adaptive relative to the particular user-item distances of a particular batch and encouraging user-item separation with regularization, both for a particular user’s items and across user-item pairs without introducing hard or pre-set thresholds for modifying the weights of the user-item pairs.

As such, using the distance between embeddings for user-item pairs, the respective weight components may be determined for each user-item pair and combined to determine a total weight for the user-item pair in the training batch. For the positive user-item pairs, the weight may be used to affect the magnitude of the “pull” that promotes moving the user embedding and item embedding together (i.e., decreasing the distance). For negative user-item pairs, the weight may be used to affect the magnitude of the “push” that promotes moving the user embedding and item embedding farther apart (i.e., increasing the distance). After determining the respective weights for each user-item pair, the resulting “push” and “pull” (as affected by the weights) may then be accumulated for individual user and item embeddings based on the associated user-item pairs and used to adjust the positions of the embeddings for that training iteration. As noted above, various training procedures and recommendation models may use additional parameters that may also be modified based on the weights of the user-item pairs.

### Experimental Results

Together, the selection of “hard” positive and negative pairs based on the respective distance of another type (e.g., positive pairs selected based on the closest negative pair, and negative pairs selected based on the farthest positive pair), along with the various weight components, permits a particular training iteration to account for the difference in interaction types (e.g., positive/negative in the selection of training pairs), along with the item and user’s position not, only for itself but also in the context of other items in the batch. These modifications to the training process also significantly improve performance of trained embeddings for a variety of different recommendation model architectures.

Jointly, these components convey both local context on how the target item relates to the user, and global context on how the item relates to other items of the same type from the target user, as well as other users in the dataset. Combining local and global contexts enables the model to enforce stricter consistency on the embedding space which, as shown by the experiments below, leads to better separation of the user-item embeddings and significant accuracy improvement.

The loss function shown in Equation 1 (i.e., L_{MCL}) with weight components discussed above were used to train different recommendation model types with respect to different data sets shown in Table 1:

TABLE 1

Dataset Statistics

| Dataset | #User | #Item | #Interactions | Density |
|---|---|---|---|---|
| Amazon-Digital-Music | 5,541 | 3,568 | 46,846 | 0.237% |
| Amazon-Grocery | 14,684 | 8,713 | 108,017 | 0.084% |
| Amazon-Books | 52,406 | 41,264 | 1,856,747 | 0.086% |
| Yelp2021 | 97,462 | 48,294 | 2,209,755 | 0.047% |

The example of Table 1 shows the number of users, items, and interactions of the respective data sets, and illustrates the sparsity of user-item interactions. The datasets vary in size and density, providing a comprehensive view of trained model performance. The experimental results shown below are based on a randomly selected 80% of the interactions for training and 10% for validation and 10% for testing. To evaluate top-k ranking performance for each model, two widely used metrics were used: Recall and Normalized Discounted Cumulative Gain (NDCG).

Various recommendation model architectures were trained for these data sets using different loss functions. The model architectures include Collaborative Metric Learning (“CML”), Neural Matrix Factorization (“NeuMF” or “Neural Collaborative Filtering”), and LightGCN (a ‘light’ graph convolutional network model) and were trained with the base model and with various loss functions for evaluation. The different loss functions are designated in Table 2 below with a + to indicate the loss function used, in which MCL designates the loss of Equation 1. The additional loss functions include symmetric metric learning with adaptive margin (SML) and that uses an adaptive bias for each user and “Simplify and Robustly Negative Sampling for Implicit Collaborative Filtering” (“SRNS”) that reduces the false negative instances during the sampling process.

In these experiments, the embedding dimension is set to 64 and ratio of negative pairs for each positive pair to 10. For temperature parameters, α was selected from

$$\left\{1 , \frac{5}{4} , \frac{5}{3} , \frac{5}{2} , 5\right\}$$

and β from {1, 2, 3, 4, 5}. The margin parameters, λₚ and λₙ are chosen from {0, 0.5, 1, ..., 9.5, 10} and {-3, -2.5, ..., 2.5, 3} respectively. The mining margin ∈ was fixed to 1. All hyper-parameters for the Mixed-Centric Loss were set through cross validation and the batch size was 1.000 users for each dataset. [symbol] Table 2 shows results on Recall (top) and NDCG (bottom) results for all datasets with CML, NeuMF, and LightGCN as base models. The best performing model for each dataset and base model is highlighted in bold and next best model is underlined. Models trained with SML, SRNS, and the Mixed Centric Loss (L_{MCL} of Equation 1) are indicated with “+SML”, “+SRNS”, and “+MCL” respectively. Relative improvements comparing to the second-best model are shown in brackets. As shown by Table 2, training based on embodiments discussed herein result in significant performance improvements relative to prior approaches across all tested recommendation model architectures.

An important factor for the high performance of this loss is the batch-type weight component that adds global information from other users within the batch. This component acts as a regularizer and encourages items of the same type (positive or negative) to be within comparable distance for every user. To further evaluate the effect that MCL learning has on the embedding space the learned embeddings are projected to a one-dimensional space with t-SNE.

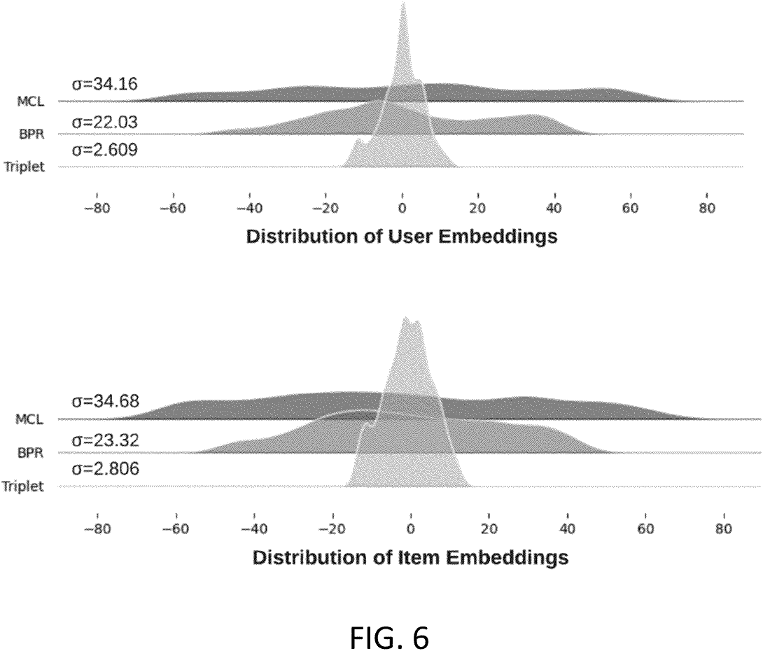

FIG. 6 shows an example distribution of user and item embeddings with different loss functions, according to one embodiment. The same LightGCN model architecture was trained with Triplet, BPR, and MCL losses on the Amazon-Digital-Music dataset, plots of the projected embeddings are shown in FIG. 6. FIG. 6 shows the distributions of the 1D projected user and item embeddings and the corresponding standard deviations. Both user and item distributions for the Triplet loss are highly peaked with a small standard deviation. The BPR loss is able to correct some of these drawbacks by using a dynamic weighting scheme that depends on the relative difference between pair distances. BPR’s 1D projection has more than 10x larger standard deviation than the Triplet loss. The MCL loss further increases the standard deviation by over 50% relative to BPR. This in turn leads to a significant accuracy improvement where MCL boosts Recall@20 by 16% and 10% over Triplet and BPR losses, respectively.

To evaluate the effect of other hyperparameters on our loss, different settings with β = 5,

$$α ∈ \left\{1 , \frac{5}{4} , \frac{5}{3} , \frac{5}{2} , 5\right\}$$

and α = 1, β ∈ {1, 2, 3, 4, 5} while λₚ and λₙ are fixed to 0. Then, λₚ ∈ {2, 4, 6, 8, 10} and λₙ ∈ {-3, -1, 0, 1, 3} were tested while fixing α and β to the best settings from the previous test.

For both datasets, the peak performance occurs when the ratio α/β is

$$4 \left(α = \frac{5}{4} ,\right)$$

β = 5 for Amazon-Digital-Music; α = 1, β = 4 for Amazon-Books). Since the ratio of a and β determines the weight split between positive and negative pairs, the result indicates that the positive pairs should receive four times more weight than the negative pairs to yield the best result.

For both datasets, the optimal value for λₚ lies in the range of 6 to 8 while λₙ is in the range of negative 1 to zero. In this example, the difference may be due to the Euclidean distance separation between positive and negative pairs. Since Eᵤⱼ « Eᵤₖ, a large λₚ and a small λₙ makes the magnitudes of Eᵤⱼ +λₚ and Eᵤₖ +λₙ similar in the user-item weight components w₁ (u, j) and w₁ (u, k).

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for training a set of user embeddings and a set of item embeddings for user-item recommendation, comprising:
a processor that executes instructions;
a non-transitory computer-readable medium having instructions executable by the processor for:
identifying a training set of user-item pairs for a respective user of a set of users with respect to a respective item of a set of items, the user-item pairs including positive user-item pairs labeled with a positive interaction type and negative user-item pairs labeled with a negative interaction type;
determining, for each user-item pair in the training set of user-item pairs, a distance between a user embedding, of a plurality of user embeddings, associated with the respective user and an item embedding, of a plurality of item embeddings, associated with the respective item;
determining a weight for each user-item pair in the training set of user-item pairs based on the distance of the user-item pair and the distance of at least one other user-item pair labeled with the same interaction type; and
training the plurality of user embeddings and the plurality of item embeddings based on the training set of user-item pairs and determined weight of each user-item pair.

2. The system of claim 1, wherein the weight for a user-item pair has a component that increases for a positive interaction when the distance for the user-item pair increases.

3. The system of claim 1, wherein the weight for a user-item pair has a component that increases for a positive interaction when the distance is relatively high compared to other positive interactions for the same user.

4. The system of claim 1, wherein the weight for a user-item pair has a component that increases for a positive interaction when the distance is relatively high compared to other positive interactions for different users.

5. The system of claim 1, wherein the weight for a user-item pair has a component that increases for a negative interaction when the distance for the user-item pair decreases.

6. The system of claim 1, wherein the weight for a user-item pair has a component that increases for a negative interaction when the distance is relatively low compared to other negative interactions for the same user.

7. The system of claim 1, wherein the weight for a user-item pair has a component that increases for a negative interaction when the distance is relatively low compared to other negative interactions for different users.

8. The system of claim 1, wherein the instructions are further executable for identifying the training set of user-item pairs, including identifying a user-item pair having the negative interaction type with a minimum distance to a user and selecting user-item pairs having the positive interaction type for the training set that are within a threshold distance of the minimum distance.

9. The system of claim 1, wherein the instructions are further executable for identifying the training set of user-item pairs, including identifying a user-item pair having the positive interaction type with a maximum distance to a user and selecting user-item pairs having the negative interaction type for the training set that are within a threshold distance of the maximum distance.

10. The system of claim 1, wherein the instructions are further executable for training the plurality of user embeddings and the plurality of item embeddings includes training parameters of a recommendation model.

11. A method for training a set of user embeddings and a set of item embeddings for user-item recommendation, comprising:
identifying a training set of user-item pairs for a respective user of a set of users with respect to a respective item of a set of items, the user-item pairs including positive user-item pairs labeled with a positive interaction type and negative user-item pairs labeled with a negative interaction type;
determining, for each user-item pair in the training set of user-item pairs, a distance between a user embedding, of a plurality of user embeddings, associated with the respective user and an item embedding, of a plurality of item embeddings, associated with the respective item;
determining a weight for each user-item pair in the training set of user-item pairs based on the distance of the user-item pair and the distance of at least one other user-item pair labeled with the same interaction type; and
training the plurality of user embeddings and the plurality of item embeddings based on the training set of user-item pairs and determined weight of each user-item pair.

12. The method of claim 11, wherein the weight for a user-item pair has a component that increases for a positive interaction when the distance for the user-item pair increases.

13. The method of claim 11, wherein the weight for a user-item pair has a component that increases for a positive interaction when the distance is relatively high compared to other positive interactions for the same user.

14. The method of claim 11, wherein the weight for a user-item pair has a component that increases for a positive interaction when the distance is relatively high compared to other positive interactions for different users.

15. The method of claim 11, wherein the weight for a user-item pair has a component that increases for a negative interaction when the distance for the user-item pair decreases.

16. The method of claim 11, wherein the weight for a user-item pair has a component that increases for a negative interaction when the distance is relatively low compared to other negative interactions for the same user.

17. The method of claim 11, wherein the weight for a user-item pair has a component that increases for a negative interaction when the distance is relatively low compared to other negative interactions for different users.

18. The method of claim 11, wherein identifying the training set of user-item pairs includes identifying a user-item pair having the negative interaction type with a minimum distance to a user and selecting user-item pairs having the positive interaction type for the training set that are within a threshold distance of the minimum distance.

19. The method of claim 11, wherein identifying the training set of user-item pairs includes identifying a user-item pair having the positive interaction type with a maximum distance to a user and selecting user-item pairs having the negative interaction type for the training set that are within a threshold distance of the maximum distance.

20. The method of claim 11, wherein training the plurality of user embeddings and the plurality of item embeddings includes training parameters of a recommendation model.
